(19) United States
(12) Patent Application Publication
(10) Pub. No.: US 2026/0131286 A1
(43) Pub. Date: May 14, 2026

(54) WATER TREATMENT SYSTEMS

(71) Applicant: PACIFIC ADVANCED CIVIL ENGINEERING, INC., Fountain Valley, CA (US)

(72) Inventor: Andrew Komor, Costa Mesa, CA (US)

(21) Appl. No.: 19/385,015

(22) Filed: Nov. 10, 2025

Related U.S. Application Data
(60) Provisional application No. 63/718,976, filed on Nov. 11, 2024.

(51) Int. Cl. B01D 61/02; B01D 61/12; B01D 65/02; C02F 1/00; C02F 1/44; C02F 101/30; C02F 103/06

(52) U.S. Cl. CPC B01D 61/026; B01D 61/12; B01D 65/02; C02F 1/008; C02F 1/441; B01D 2313/083; B01D 2313/18; B01D 2317/022; B01D 2321/02; C02F 2101/30; C02F 2103/06; C02F 2201/005; C02F 2301/043; C02F 2301/08; C02F 2303/04; C02F 2303/16

(57) ABSTRACT

A water treatment system can include a first group of pressure vessels operable to rotate between a first treatment stage mode of operation, a third treatment stage of operation, and a flush or rest mode. The system can include a second group of pressure vessels operable in a second treatment stage mode of operation. The water treatment system can be a desalination water treatment system. The system can include four water treatment skids that are each divided into two banks to provide eight banks of pressure vessels. The water treatment system can include one or more bypass valves that are operable to bypass one or more of the pressure vessels to operate the water treatment system in a two stage treatment mode.

### CROSS-REFERENCE TO RELATED APPLICATIONS

This application claims the benefit under 35 U.S.C. § 119(e) of U.S. Provisional Patent Application No. 63/718,976, filed Nov. 11, 2024, and titled WATER TREATMENT SYSTEMS. The entirety contents of each of the above-identified application(s) are hereby incorporated by reference herein and made part of this specification for all that they disclose.

### BACKGROUND

### Field of the Disclosure

Some embodiments disclosed herein relate to water treatment systems, such as for desalination.

### Description of the Related Art

Although various water treatment systems are known, there remains an ongoing need for improved water treatment systems.

### SUMMARY OF CERTAIN EMBODIMENTS

Certain example aspects of the present disclosure are summarized below for illustrative purposes. The disclosure is not limited to the specific implementations recited herein. Aspects of the disclosure may include several novel features, no single one of which is solely responsible for its desirable attributes.

Various aspects of the disclosure relate to a water treatment system, which can include an input configured to receive input water for treatment and eight banks of pressure vessels. Four of the eight banks of pressure vessels can be operable to: receive the input water, perform a first stage treatment on the input water, output first stage permeate water, and output first stage output water. Two of the eight banks of pressure vessels can be operable to receive the first stage output water, perform a second stage treatment on the first stage output water, output second stage permeate water, and output second stage output water. One of the eight banks of pressure vessels can be operable to receive the second stage output water, perform a third stage treatment on the second stage output water, output third stage permeate water, and output third stage output water. One of the eight banks of pressure vessels can be in a rest or flush state.

The water treatment system can be a desalination water treatment system. The water treatment system can use reverse osmosis. The water treatment system can be operable to rotate six of the eight banks of pressure vessels between a first stage treatment mode of operation, a third stage treatment mode of operation, and the rest or flush state. The two of the eight banks that are operable to perform the second stage treatment can operable to continue performing the second stage treatment while the six of the eight banks are rotated between the first stage treatment mode of operation, the third stage treatment mode of operation, and the rest or flush state. The system can include a controller that is configured to operate a plurality of valves to automatically rotate the six of the eight banks. The rest or flush state can be a flush state in which the water treatment system is operable to deliver flushing fluid to the pressure vessels of the one of the eight banks that is in the flush state. The rest or flush state can be a rest state in which the water treatment system is operable to isolate the pressure vessels of the one of the eight banks that is in the rest state. The treatment system can include four water treatment skids that are each divided into two banks to provide the eight banks of pressure vessels. One of the water treatment skids can include a single frame that supports the pressure vessels of two of the eight banks. The water treatment system can include one or more bypass valves that are operable to bypass the two of the eight banks of pressure vessels to operate the water treatment system in a two stage treatment mode using six of the banks of pressure vessels. In the two stage treatment mode four of the six banks of pressure vessels can be operable to receive the input water, perform a first stage treatment on the input water, output first stage permeate water, and output first stage output water. In the two stage treatment mode two of the six banks of pressure vessels can be operable to receive the first stage output water, perform a second stage treatment on the first stage output water, output second stage permeate water, and output second stage output water. The bypassed two of the eight banks can be in a flush or rest state in the two stage treatment mode. The water treatment system can be operable to rotate the six of the eight banks of pressure vessels between a first stage treatment mode of operation, and a second stage treatment mode of operation.

Various aspects of the disclosure relate to a water treatment system, which can include a first water treatment skid that includes a first bank of pressure vessels and a second bank of pressure vessels, a second water treatment skid that includes a third bank of pressure vessels and a fourth bank of pressure vessels, a third water treatment skid that includes a fifth bank of pressure vessels and a sixth bank of pressure vessels, and a fourth water treatment skid that includes a seventh bank of pressure vessels and an eighth bank of pressure vessels.

The water treatment system can be operable to rotate the first bank, the second bank, the third bank, the fourth bank, the fifth bank, and the sixth bank between a first stage treatment mode of operation, a third stage treatment mode of operation, and a rest or flush mode. The water treatment system can be operable to operate the seventh bank and the eighth bank in a second stage treatment mode of operation. The water treatment system can be configured to operate four of the banks one to six in the first stage treatment mode of operation, operate one of the banks one to six in the third stage treatment mode of operation, and operate one of the banks one to six in the rest or flush mode. Each skid can include a shared frame that supports the pressure vessels for two banks. The water treatment system can include a bypass valve that is operable to bypass the seventh bank and the eighth bank so that the banks one to six operate in a two stage treatment mode. The water treatment system can include valves operable to independently operate the first bank, the second bank, the third bank, the fourth bank, the fifth bank, and the sixth bank in a first treatment stage mode of operation, a third treatment stage mode of operation, and a flush mode of operation. The first bank, the second bank, the third bank, the fourth bank, the fifth bank, and the sixth bank can each include a first stage input valve and a first stage output valve that are operable to open to operate the respective bank in a first treatment stage mode of operation, a third stage input valve and a third stage output valve that are operable to open to operate the respective bank in a third treatment stage mode of operation, and a flush input valve and a flush output valve that are operable to open to flush the respective bank. The first stage input valve, the first stage output valve, the third stage input valve, the third stage output valve, the flush input valve, and the flush output valve can be operable to close to put the respective bank in an isolation mode. The water treatment system can be a desalination water treatment system. The water treatment can be a reverse osmosis water treatment system.

Various aspects of the disclosure relate to a water treatment system, which can include a first group of pressure vessels and one or more valves operable to selectively operate the first group in a first treatment stage mode of operation, a third treatment stage mode of operation, and a flush or rest mode of operation; a second group of pressure vessels and one or more valves operable to selectively operate the second group in the first treatment stage mode of operation, the third treatment stage mode of operation, and the flush or rest mode of operation; a third group of pressure vessels and one or more valves operable to selectively operate the third group in the first treatment stage mode of operation, the third treatment stage mode of operation, and the flush or rest mode of operation; a fourth group of pressure vessels and one or more valves operable to selectively operate the fourth group in the first treatment stage mode of operation, the third treatment stage mode of operation, and the flush or rest mode of operation; a fifth group of pressure vessels and one or more valves operable to selectively operate the fifth group in the first treatment stage mode of operation, the third treatment stage mode of operation, and the flush or rest mode of operation; a sixth group of pressure vessels and one or more valves operable to selectively operate the sixth group in the first treatment stage mode of operation, the third treatment stage mode of operation, and the flush or rest mode of operation; and a seventh group of pressure vessels operable in a second treatment stage mode of operation.

The water treatment system can further include an eighth group of pressure vessels operable in the second treatment stage mode of operation. A first frame can support the first group of pressure vessels and the second group of pressure vessels. A second frame can support the third group of pressure vessels and the fourth group of pressure vessels. A third frame can support the fifth group of pressure vessels and the sixth group of pressure vessels. A fourth frame can support the seventh group of pressure vessels and the eighth group of pressure vessels. Each of the groups of pressure vessels can include the same number of pressure vessels. The water treatment system can include a controller operable to rotate the first group of pressure vessels, the second group of pressure vessels, the third group of pressure vessels, the fourth group of pressure vessels, the fifth group of pressure vessels, and the sixth group of pressure vessels between the first treatment stage mode of operation, the third treatment stage mode of operation, and the flush or rest mode of operation. The controller can be configured to operate four of the groups of pressure vessels in the first treatment stage mode of operation, to operate one group of the pressure vessels in the third treatment stage mode of operation, and to operate one group of the pressure vessels in the flush or rest mode of operation. The water treatment system can include one or more valve configured to bypass the seventh group of pressure vessels. The water treatment system can be operable in a two stage treatment mode, such as when the seventh group of pressure vessels is bypassed.

Various aspects of the disclosure relate to a water treatment system, which can include a first group of pressure vessels operable to rotate between a first treatment stage mode of operation, a third treatment stage of operation, and a flush or rest mode, and a second group of pressure vessels operable in a second treatment stage mode of operation. The water treatment system can include any combination of the features recited herein.

Various aspects of the disclosure relate to a method of operating a water treatment system. The method can include operating a first group of pressure vessels as a first treatment stage, operating a second group of pressure vessels as a second treatment stage, operating a third group of pressure vessels as a third treatment stage, and operating a fourth group of pressure vessels in a flush or rest stage.

The third group and the fourth group can have the same number of pressure vessels, and the second group can have twice as many pressure vessels as the third group, and the first group can have twice as many pressure vessels as the second group. The method can include rotating the first, third, and fourth groups of pressure vessels between the first treatment stage, the third treatment stage, and the flush or rest stage. The method can include operating the second group of pressure vessels as the second treatment stage while rotating the first, third, and fourth groups of pressure vessels. The method can include relieving pressure changes through the fourth group of pressure vessels that are in the flush or rest stage when rotating the first, third, and fourth groups the pressure vessels. The method can include transitioning the fourth group of pressure vessels to operate as the first treatment stage; operating the first group and the fourth group as the first treatment stage during a first time delay; after the first time delay, transitioning a subset of the pressure vessels of the first group to operate as the third treatment stage; operating the subset of the first group and the third group as the third treatment stage during a second time delay; and after the second time delay, transitioning the third group of pressure vessels be in the flush or rest stage. The first, third, and fourth groups of pressure vessels can make up six rotatable banks of pressure vessels. Three water treatment skids can be divided in half to provide the six rotatable banks of pressure vessels. The second group can make up two additional banks of pressure vessels on a fourth water treatment skid. The method can include opening a bypass valve to transition to a two stage treatment mode that bypasses the second group of pressure vessels. The method can include operating a first subset of the pressure vessels of the first, third, and fourth groups as a first treatment stage, and operating a second subset of the pressure vessels of the first, third, and fourth groups as a second treatment stage.

### BRIEF DESCRIPTION OF THE DRAWINGS

Certain embodiments will be discussed with reference to the following figures, wherein like reference numerals can generally refer to similar features throughout. The figures are provided for illustrative purposes and the innovations are not limited to the specific implementations illustrated in the figures.

FIG. 1 shows an example of a water treatment system.

FIG. 2 shows an example water treatment system, which can include eight banks of membrane pressure vessels.

FIG. 3 shows an example of the water treatment system in a first operating configuration.

FIG. 4 shows an example of the water treatment system in a second operating configuration.

FIG. 5 shows an example of the water treatment system in a third operating configuration.

FIG. 6 shows an example of the water treatment system in a fourth operating configuration.

FIG. 7 shows an example of the water treatment system in a fifth operating configuration.

FIG. 8 shows an example of the water treatment system in a sixth operating configuration.

FIG. 9 shows an example embodiment of a water treatment system in a modified first operating configuration in which the bank VI is in rest mode rather than flush mode.

FIG. 10 shows an example method for transitioning between operational configurations for the water treatment system.

FIG. 11 shows an example of the system in the first operational configuration of the two-stage mode.

FIG. 12 shows an example of the system in the second operational configuration of the two-stage mode.

FIG. 13 shows an example of the system in the third operational configuration of the two-stage mode.

FIG. 14 shows an example of the system in the fourth operational configuration of the two-stage mode.

FIG. 15 shows an example of the system in the fifth operational configuration of the two-stage mode.

FIG. 16 shows an example of the system in the sixth operational configuration of the two-stage mode.

FIG. 17 shows and example of the sixth operational configuration of the two-stage mode in which the stage two flush valves are closed, and the banks VII and VIII are in the rest mode.

FIG. 18 shows a perspective view of an example embodiment of a fluid treatment system.

FIG. 19 shows an elevation side view of Skid B, showing bank III of the example embodiment of the fluid treatment system.

FIG. 20 is an elevation front view of Skid B, showing banks III and IV of the example embodiment of the fluid treatment system.

FIG. 21 is a plan view of the example embodiment of the fluid treatment system.

FIG. 22 is an elevation front view of the example embodiment of the fluid treatment system.

### DETAILED DESCRIPTION OF CERTAIN EMBODIMENTS

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

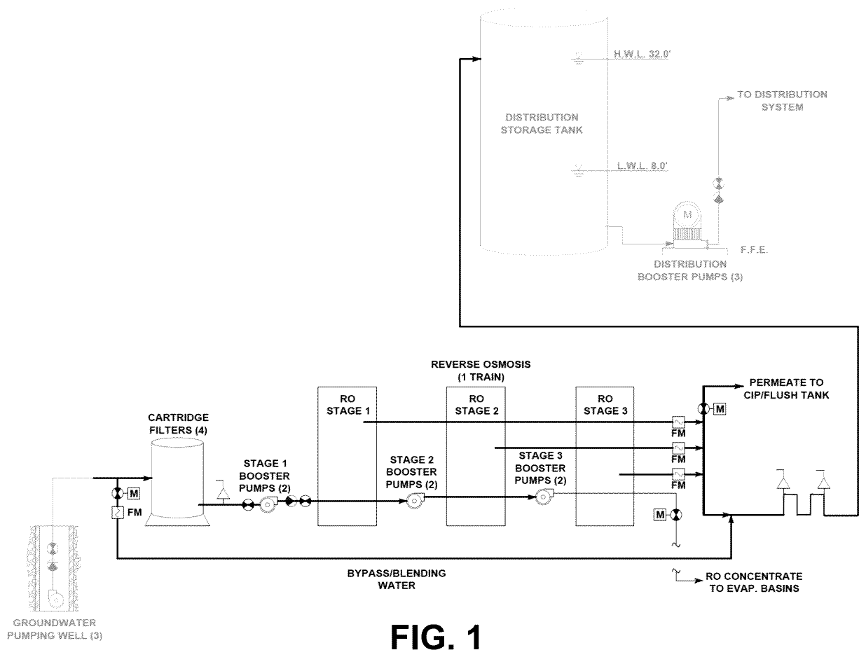

FIG. 1 shows an example of a water treatment system. The water treatment system can be used for desalination, or for other types of water treatment. The water treatment system can receive water for treatment, such as from a groundwater well or from any other suitable water source. The water treatment system can include one or more filters, such as cartridge filters, for filtering the incoming water. The one or more filters can be configured to filter out particulate matter from the water, in some cases.

The water treatment system can use reverse osmosis (RO) to treat the water. The water treatment system can be configured to remove contaminants such as dissolved salts, bacteria, viruses, and organic matter, etc. from the water. In some implementations, the water treatment system can be used for desalination. The water treatment system can include a first RO stage, a second RO stage, and a third RO stage. One or more stage one pumps can provide pressurized water to the first RO stage. The first RO stage can output permeate (e.g., clean or treated water) and untreated water (e.g., brine). The untreated water (e.g., brine) output from the first RO stage can be provided to the second RO stage. One or more stage two pumps can provide pressurized water to the second RO stage. The second RO stage can output permeate (e.g., clean or treated water) and untreated water (e.g., brine). The untreated water (e.g., brine) output from the second RO stage can be provided to the third RO stage. One or more stage three pumps can provide pressurized water to the third RO stage. The third RO stage can output permeate (e.g., clean or treated water) and untreated water (e.g., brine). The untreated water (e.g., brine) output from the third RO stage can be sent to waste, or sent to an evaporative basin, or dumped.

The treated water (e.g., output permeate from the RO stages) can be sent to a distribution tank, and one or more distribution pumps can output the treated water from the distribution tank to the distribution system, for example. In some implementations, the treated water (e.g., permeate) can be sent to a clean-in-place (CIP) or flush tank, which can supply water for cleaning or flushing the RO system, as discussed herein. In some cases, the system can include a bypass line, which can bypass the one or more cartridge filters and/or the one or more RO stages. The bypass line can deliver untreated water to the output of the system, such as to the distribution tank and/or to the CIP or flush tank. In some cases, the bypass line can be used for blending untreated water with the treated water.

One or more valves can be opened and closed to control the flow of water through the system. For example, a valve can open to permit treated water to be delivered to the CIP or flush tank, and the valve can close to impede the treated water from flowing to the CIP or flush tank. A valve can open to permit water to flow through the bypass line, and the valve can close to impede water from flowing through the bypass line. A valve can open to permit brine to flow to a waste (e.g., to a waste tank, or evaporative basin, or dump site), and the valve can close to impede the brine from flowing to waste. One or more valves can open to permit water to flow into the first RO stage, and the one or more valves can close to impede water from flowing into the first RO stage. Additional valves can be included, as discussed herein, such as for controlling flow of fluid between the first RO stage, the second RO stage, and the third RO stage, or for controlling the flow of CIP of flushing fluid to one or more of the RO stages. The water treatment system can include one-way or check valves, such as at output from the water source (e.g., the groundwater well), at an input to the first RO stage, and/or at an output to the distribution system. Check valves can be located at various other locations to control the flow of fluid through the system, as discussed herein.

The RO stages can include one or more membrane pressure vessels (e.g., reverse osmosis filters). In some embodiments, the first RO stage can include a first number of membrane pressure vessels, which can process the incoming water and can output about half permeate (e.g., clean water) and about half brine. The second RO stage can process the brine output from the first RO stage, which can be a about half the volume of water processed by the first RO stage. Accordingly, the second RO stage can include a second number of membrane pressure vessels, which can be about half the first number of membrane pressure vessels. The brine processed by the second RO stage can have about double the concentration of contaminants (e.g., salt) as the water processed by the first RO stage. The second RO stage can output can output about half permeate (e.g., clean water) and about half brine. The third RO stage can process the brine output from the second RO stage, which can be a about half the volume of water processed by the second RO stage, and about a quarter of the volume of water processed by the first RO stage. Accordingly, the third RO stage can include a third number of membrane pressure vessel(s), which can be about half the second number of membrane pressure vessels, and which can be about a quarter of the first number of membrane pressure vessels. The brine processed by the third RO stage can have about double the concentration of contaminants (e.g., salt) as the water processed by the second RO stage, and about four times the concentration of contaminants as the water processed by the first RO stage.

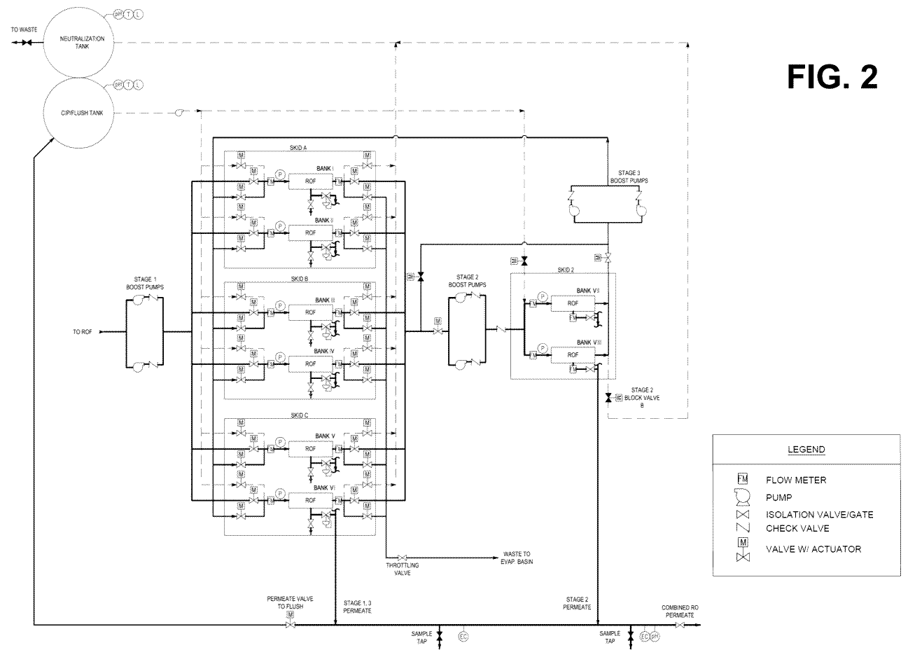

FIG. 2 shows an example water treatment system, which can include eight banks of membrane pressure vessels (e.g., reverse osmosis filters). Each bank can include one or more membrane pressure vessels. Each bank can include the same number of membrane pressure vessels. The system can use four of the banks for the first RO stage. The system can use two of the banks for the second RO stage. The system can use one of the banks for the third RO stage. The system can have one bank in a rest state while the other seven banks operate to treat the water.

In some implementations, the system can include four RO skids. Each skid can be divided into two banks, so that the four skids can provide eight banks. In FIG. 2, skid A can include bank I and bank II, skid B can include bank III and bank IV, skid C can include banks V and VI, and skid D can include banks VII and VIII. Many variations are possible. For example, in some implementations, eight skids can be used and each skid can provide a single bank of membrane pressure vessels. In some implementations, two skids can be used and each skid can provide four banks. In some implementations, a single skid can be used, and the single skid can be divided into eight banks (e.g., with three membrane pressure vessels per bank in a single skid).

Since the water processed by the first RO stage has a lower concentration of contaminants than the water processed the second and third RO stages, the first RO stage can experience less degradation (e.g., membrane clogging, fouling, or damage) than the second and third RO stages. Since the water processed by the second RO stage has a concentration of contaminants that is between contamination of the water processed by the first and third RO stages, the second RO stage can experience degradation (e.g., membrane clogging, fouling, or damage) that is between the degradation experience by the first and third RO stages. Since the water processed by the third RO stage has a higher concentration of contaminants than the water processed by the first and second RO stages, the third RO stage can experience more degradation (e.g., membrane clogging, fouling, or damage) than the first and second RO stages.

The water treatment system can rotate the roles of one or more of the banks, such as to share the load across the various banks. For example, in some implementations, two of the banks (e.g., banks VII and VIII of Skid D in FIG. 2) can be configured to operate as the second RO stage, while the other six banks (e.g., banks I to VI of skids A, B, and C) can alternate between operating as the first RO stage, operating as the third RO stage, and the rest stage. While four of the banks provide the first RO stage, one of the banks provides the third RO stage, and one of the banks is in the resting state. After a time, the role of the third RO stage can be changed to one of the other banks (e.g., to one of the banks that was operating as the first RO stage), and the rest stage can be changed as well. For example, the bank that was operating as the third RO stage can thereafter transition to the rest stage. Alternatively, one of the banks that was operating as the first RO stage can transition to the rest stage. The bank that was operating as the rest stage can thereafter transition to the first RO stage, or alternatively to the third RO stage. The rotation of the first RO stage, the third RO stage, and the rest stage can be configured to divide the roles substantially evenly between the six banks. For example, during six rotations, each bank can spend four of the rotations operating as the first RO stage, one of the rotations operating as the third RO stage, and one of the rotations operating as the rest stage. It can be advantageous for the rest stage to follow immediately after the third RO stage in the rotation because the third RO stage can be the most stressful stage.

When a bank is in the rest stage, the RO filters of that stage can be flushed, such as with clean water or with a cleaning solution or chemical, such as from a clean-in-place (CIP) or flush tank, while the rest of the system continues in normal operation to treat the water. In some cases, the rest stage can merely be a period of rest for the bank, and no fluid is flushed through the bank. In some cases, the flushing and/or cleaning solution can be applied during the resting stages periodically or intermittently or as needed. Also, repairs or maintenance can be performed on the bank that is in the rest stage, while the rest of the system continues in normal operation to treat the water. If a particular bank has a malfunction or otherwise is in need of repair or maintenance, the system can transition to the configuration in which that bank is in the resting stage (e.g., in response to user input), and the repair or maintenance can be performed without interrupting the water treatment performed by the system.

The system can include valves to control the flow of fluid between the various banks and other components of the system. Each of the banks I to VI can include a flush input valve, a first stage input valve, and a third stage input valve, which are shown on the left side of the respective banks in FIG. 2, arranged from top to bottom. Each of the banks I to VI can include a flush output valve, a first stage output valve, and a third stage output valve, which are shown on the right side of the respective banks in FIG. 2, arranged from top to bottom.

The system can include a fluid inlet line, which can receive water to be processed. The fluid inlet line can receive filtered water, in some implementations, such as water output from one or more cartridge filters (e.g., pressure vessel filtrate in FIG. 2). The fluid inlet line can be coupled to the membrane pressure vessels (e.g., reverse osmosis filters) of banks I to VI (e.g., to the inputs thereof) via fluid lines. The first stage input valves and first stage output valves can be opened to operate any combination of the respective banks I to VI (e.g., four of the banks) as the first RO stage. The system can include one or more first stage pumps, which can pressurize the water for the first RO stage, such as the water that is delivered to the fluid inlet line or to the first stage inlet valves.

The membrane pressure vessels of the banks I to VI (e.g., the outputs thereof) can be coupled to the membrane pressure vessels of banks VII and VIII (e.g., the inputs thereof) via fluid lines, and water output from the banks operating as the first RO stage can be delivered to the banks VII and VIII, which can operate as the second RO stage. One or more second stage pumps (e.g., two pumps shown in FIG. 2) can be used to pressurize the water for the second RO stage. A second stage input valve and a second stage output valve can be opened to permit fluid flow through the banks VII and VIII to implement the second RO stage. In FIG. 2, the second stage input valve is before the second stage pumps and the second stage output valve is located near the top center of the diagram. Other configurations are possible. For example, each of the banks VII and VIII can have dedicated second stage input valves and second stage output valves, or the second stage input valve could be positioned after the second stage pumps, or any other suitable configuration can be used.

The membrane pressure vessels of banks VII and VIII (e.g., the outputs thereof) can be coupled to the membrane pressure vessels of banks I to VI (e.g., the inputs thereof) via fluid lines, and water output from the banks VII and VIII operating as the second RO stage can be delivered to any of the banks I to VI (e.g., one of the banks), which can operate as the third RO stage. One or more third stage pumps can be used to pressurize the water for the third RO stage. A third stage input valve and a third stage output valve can be opened to permit water to flow through the respective bank to operate as the third RO stage. The membrane pressure vessels of banks I to VI (e.g., the outputs thereof) can be coupled to a waste output via fluid lines. The waste output can lead to an evaporative basin, for example, as noted in FIG. 2. The third stage output valve for the bank operating as the third RO stage can be opened to deliver the water output from the third RO stage to the waste output.

A source of flushing or cleaning fluid (e.g., the CIP/flush tank) can be coupled to the membrane pressure vessels (e.g., the inputs thereof) of banks I to VI via fluid lines. The flush input valves and the flush output valves can be opened to permit the flushing or cleaning fluid to flow through the membrane pressure vessels. The membrane pressure vessels of banks I to VI (e.g., the outputs thereof) can be coupled to a neutralization tank via fluid lines, and the cleaning or flushing fluid can be output to the neutralization tank when the flush output valves are open. The source of flushing or cleaning fluid can be coupled to the membrane pressure vessels (e.g., the inputs thereof) of banks VII and VII, and the membrane pressure vessels (e.g., the outputs thereof) can be coupled to the neutralization tank. A second stage flush input valve (e.g., between the CIP/flush tank and the banks VII and VIII) can be opened and a second stage flush output valve (e.g., between the banks VII and VIII and the neutralization tank) can be opened to permit the flushing or cleaning fluid to flow through the membrane pressure vessels of the banks VII and VIII. In FIG. 2, the flush input is the same side as the second RO stage input, and the flush output is the same side as the second RO stage output, so that the flushing or cleaning fluid is directed in a forward direction through banks VII and VIII (e.g., the same flow direction as the second RO stage). Alternatively, the example of FIG. 2 could be modified so that the flush input for banks VII and VIII is the output side of banks VII and VIII when operating as the second RO stage, and the flushing or cleaning fluid can be directed in a reverse direction through the banks VII and VIII. One or more flush pumps (e.g., next to the CIP/flush tank in FIG. 2, although any suitable position can be used) can be used to pressurize the cleaning or flushing fluid that is delivered to the respective banks. Various alternatives are possible. The banks VII and VIII can have separate flush input valves and/or flush output valves. The flushing or cleaning fluid can be output to waster or to a holding tank or any other suitable destination (e.g., rather than the neutralization tank shown in FIG. 2).

The pressure vessels of the banks can output permeate (e.g., clean or treated water), which can be delivered via one or more permeate lines to a permeate output, which can be a storage tank or a distribution system, etc. Check valves can be used to impede the permeate from flowing backwards towards the pressure vessels. In some implementations, the system can include valves to control the output of the permeate fluid. For example, the system can selectively send permeate to the main output (e.g., to a storage tank or distribution system), or to waste, or to a cleaning or flushing fluid tank, such as by using valves. The system can include one or more permeate output valves (e.g., for each bank) that can be opened to direct the permeate to the main permeate output (e.g., to a storage tank). The system can include one or more permeate waste valves (e.g., for each bank) that can be opened to direct the permeate to waste. In some implementations, the system can include one or more permeate flush valves (e.g., for each bank) that can be opened to direct the permeate to a flush tank, so that the permeate can be used for flushing. In some cases, multi-port valves can be used.

The system can have a stage two bypass fluid line, which can couple the first stage output to the third stage input. A stage two bypass valve can open to permit fluid to bypass the second RO stage (e.g., banks VII and VIII) by traveling through the stage two bypass fluid line. In FIG. 2, the stage two bypass valve is shown closed.

Other configurations are possible. In some implementations, 2-way valves, 3-way valves, or other multi-port valves can be used. For example a 3-way valve can replace the first stage input valve, the third state input valve, and the flush input valve and/or a 3-way valve can replace the first stage output valve, the third state output valve, and the flush output valve. The 3-way valve can have a first state to couple the pressure vessels of the associated bank to the input fluid line to operate that bank as the first RO stage, a second state to couple the pressure vessels of the associated bank to the second RO stage output to operate that bank as the third RO stage, and a third state to couple the pressure vessels of the associated bank to a cleaning or flushing fluid source to flush or clean that bank. In some implementations, the multi-port valve can also include a closed state in which all three connections are closed. In some implementations, two alternative fluid paths can include one valve on only the first of the alternative paths, while the second path can be directed upward so that gravity impedes the flow of fluid along the second path if the valve on the first path is open. However, if the valve on the first path is closed, then the pressure can drive the water upward along the second path. By way of example, the fluid path for the permeate to be directed to the main output or storage tank can be directed upward, with no valve available to close that fluid path, and the fluid path that directs the permeate to waste can include a valve, which can be opened to direct the permeate to waste and can be closed to force the permeate to follow the fluid path upward and to the main output or storage tank. Many alternatives are possible, and those of skill in the art will understand that in some cases fewer valves than shown can be used, and multiple illustrated valves can be combined, and/or additional valves can be added.

Each of the banks I to VI can be selectively operated in three modes of operation: a first RO stage mode (e.g., by opening the first stage input valve and the first stage output valve), a third RO stage mode (e.g., by opening the third stage input valve and the third stage output valve), and flush mode (e.g., by opening the flush input valve and the flush output valve). In some instances, the banks I to VI can have a fourth mode of operation, which can be a rest mode, in which the pressure vessels can be isolated (e.g., by closing the first stage input valve, the first stage output valve, the third stage input valve, the third stage output valve, the flush input valve, and the flush output valve). In some implementations, the flush mode of operation can be omitted, so that the rest mode is the third mode of operation.

The banks VII and VIII can selectively operate in two modes of operation: a second RO stage mode (e.g., by opening the second stage input valve and the second stage output valve) and a flush mode (e.g., by opening the flush input valve and the flush output valve). In some instances, the banks VII and VIII can have a third mode of operation, which can be a rest mode, in which the pressure vessels can be isolated (e.g., by closing the second stage input valve, the second stage output valve, the flush input valve, and the flush output valve). In some implementations, the flush mode of operation can be omitted, so that the rest mode is the second mode of operation.

The system can be configured so that the flow of fluid through the pressure vessels can be in the same direction during the different modes of operation. For example, as shown in FIG. 2, for the pressure vessels of banks I to VI, the input valves can be on the same side of the pressure vessels (e.g., on the left in FIG. 2) and the output valves can be on the same side of the pressure vessels (e.g., on the right in FIG. 2). Alternatively, in some implementations, the fluid can be directed in different directions through the pressure vessels in different modes of operation, such as by appropriately arranging the fluid lines and associated valves. In some cases, it can be advantageous to direct the fluid through the pressure vessels in the same direction in all of the modes of operation, which can simplify the fluidics of the system, for example.

The system can operate four of the banks I to VI in the first RO stage mode of operation. The system can operate two of the bank (e.g., banks VII and VIII) in the second RO stage mode of operation. The system can operate one of the banks I to VI in the third RO stage mode of operation. The system can operate one of the banks I to VI in the flush mode of operation or in the rest mode of operation. The bank operating as the third RO stage can receive water that has more concentrated brane than the water received by the first RO stage or the second RO stage. Accordingly, the bank operating as the third RO stage can experience relatively high degradation (e.g., membrane clogging, fouling, or damage), the banks operating as the first RO stage can experience relatively low degradation, and the banks operating as the second stage can experience degradation between the high and low levels. The system can be configured to rotate the operational modes of the banks I to VI to spread the load associated with the third RO stage across the banks I to VI.

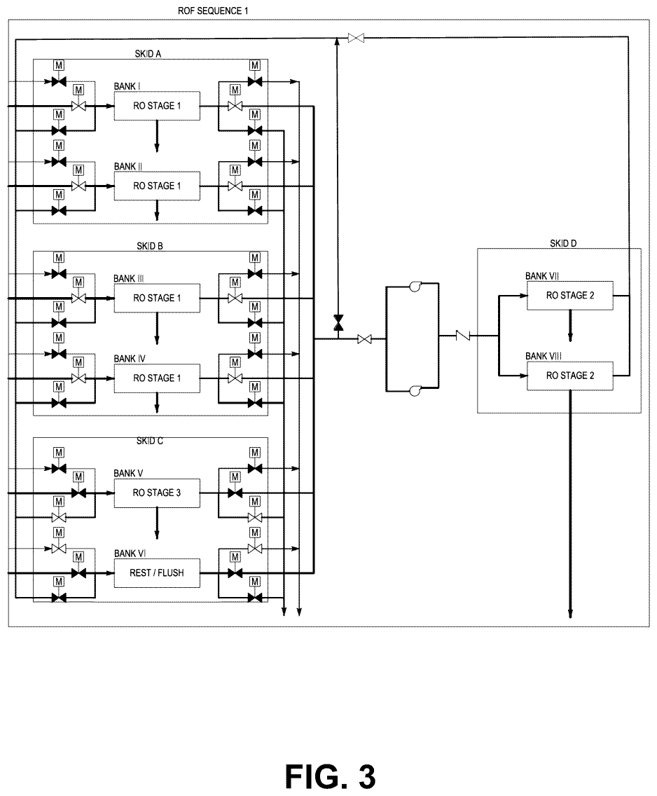

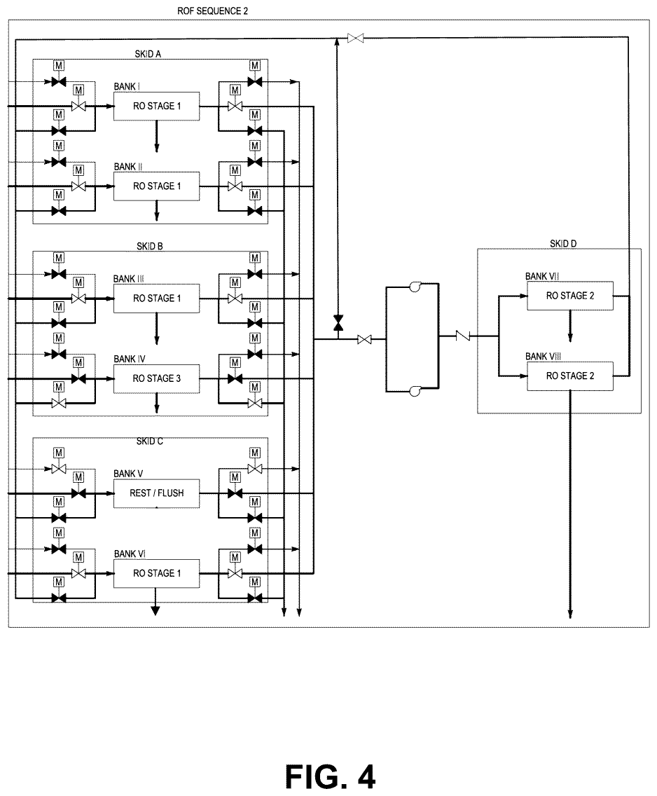

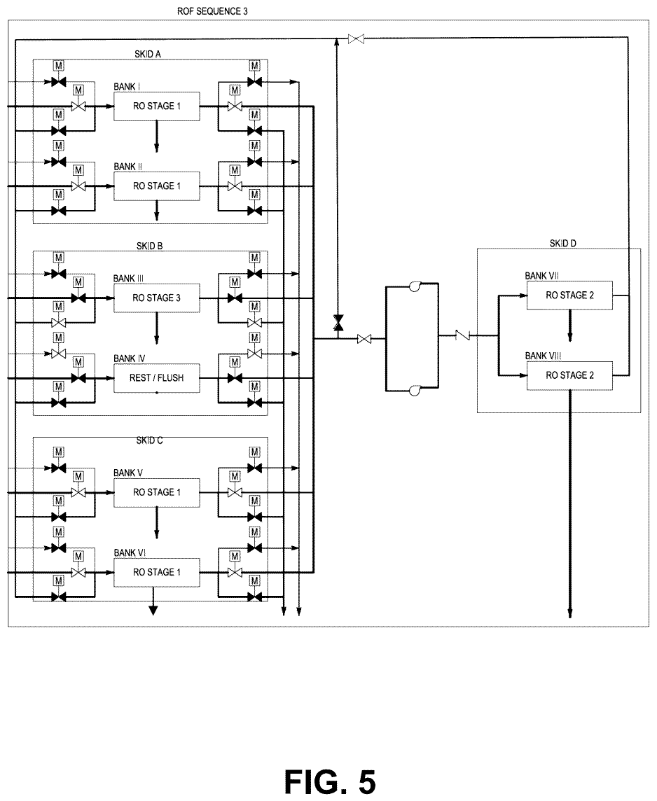

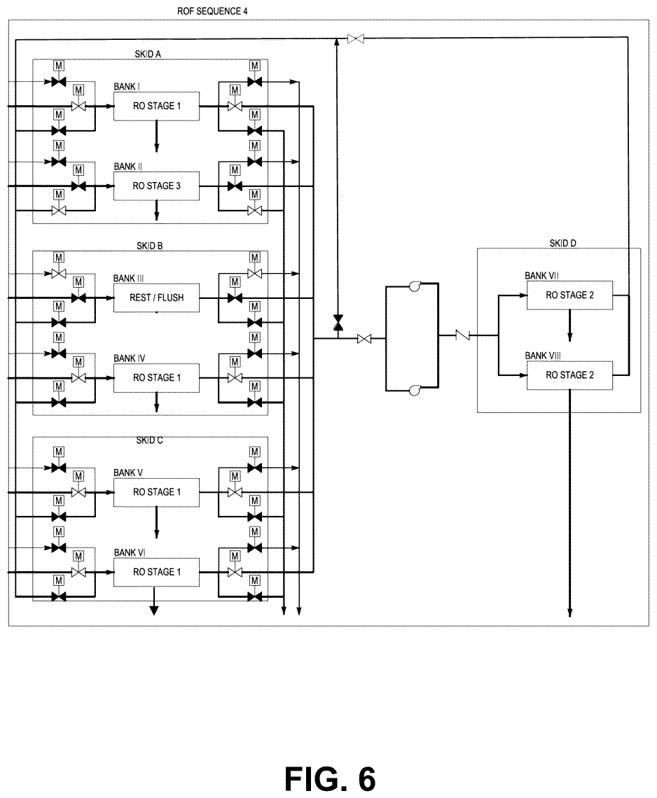

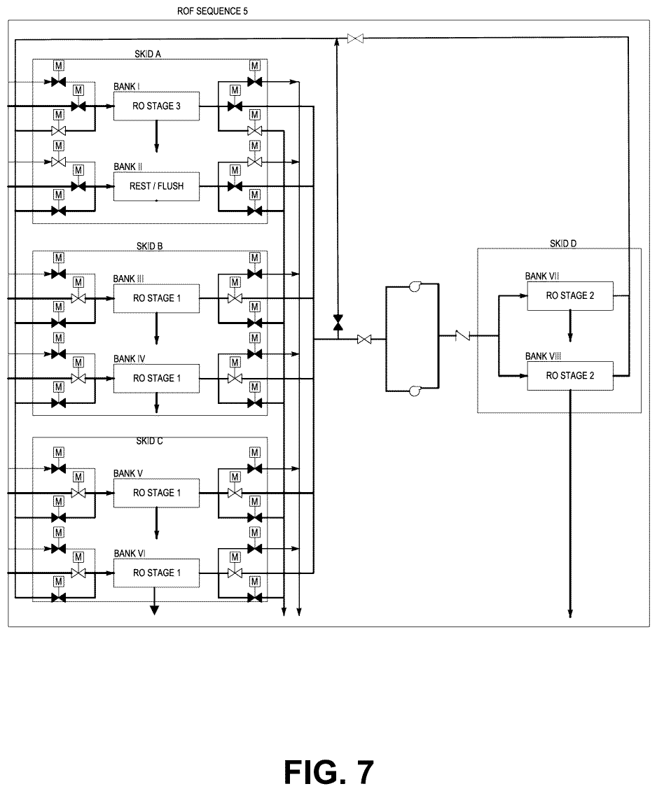

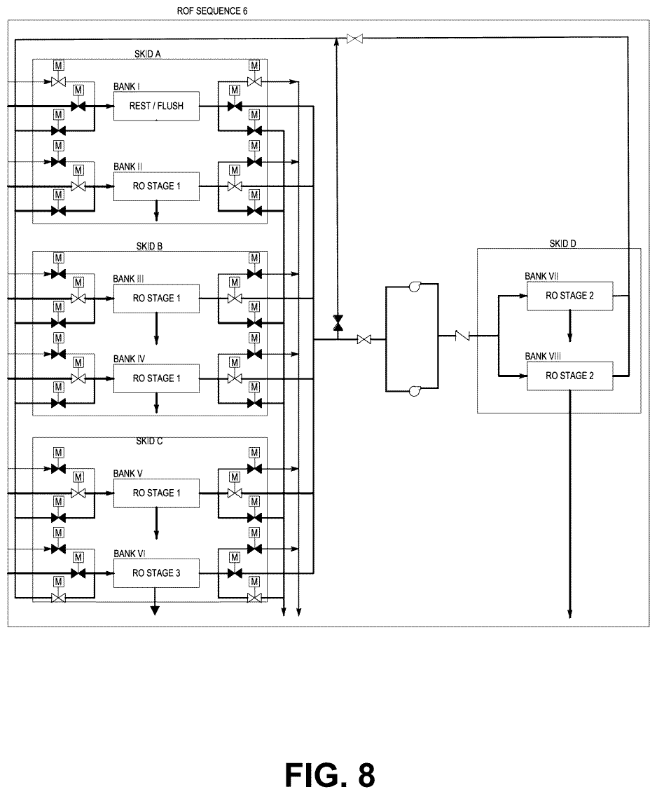

The system can have six operating configurations. FIG. 3 shows an example of a first operating configuration. FIG. 4 shows an example of a second operating configuration. FIG. 5 shows an example of a third operating configuration. FIG. 6 shows an example of a fourth operating configuration. FIG. 7 shows an example of a fifth operating configuration. FIG. 8 shows an example of a sixth operating configuration. For simplicity, various components (e.g., the stage one pumps, the stage 3 pumps, the stage two flush lines, the stage two flush input valve, the stage two flush output valve, the permeate output valves, the permeate waste valves, the input fluid line, the neutralization tank, and the CIP or flush tank) are not shown in FIGS. 3 to 8. The system of FIGS. 3 to 8 can include all the features shown in FIG. 2, or disclosed in connection with any of the embodiments disclosed herein. Table 1 shows the valve states for implementing the six operating configurations. Each operating configuration uses four of the banks I to VI for the first RO stage, one of the banks I to VI as the third RO stage, and one of the banks I to VI is in a rest or flush mode or state. The six operating configurations use the banks VII and VIII as the second RO stage. The banks for the third RO stage and the rest or flush mode can rotate across the banks I to VI in the different operating configurations. The bank that was previously operating as the third RO stage can next be transitioned to the rest or flush mode of operation. It can be advantageous to flush or rest the bank immediately after it performed the relatively high-stress operation of the third RO stage. Many alternatively are possible. For example, a bank can be operated in the flush or rest mode of operation immediately prior to operation as the third RO stage, which can be advantageous to help the bank prepare for the relatively high-stress conditions of the third RO stage. Alternatively, a bank can operate as the first RO stage immediately before and after operating as the third RO stage and/or immediately before and after the rest or flush mode of operation.

TABLE 1

| Configuration | 1 | 2 | 3 | 4 | 5 | 6 |
|---|---|---|---|---|---|---|
| Bank I - Flush Input Valve | Closed | Closed | Closed | Closed | Closed | Open |
| Bank I - Flush Output Valve | Closed | Closed | Closed | Closed | Closed | Open |
| Bank I - Stage 1 Input Valve | Open | Open | Open | Open | Closed | Closed |
| Bank I - Stage 1 Output Valve | Open | Open | Open | Open | Closed | Closed |
| Bank I - Stage 3 Input Valve | Closed | Closed | Closed | Closed | Open | Closed |
| Bank I - Stage 3 Output Valve | Closed | Closed | Closed | Closed | Open | Closed |
| Bank I - Permeate Output Valve | Open | Open | Open | Open | Open | Closed |
| (Not shown in FIGS. 3-8) | | | | | | |
| Bank I - Permeate Waste Valve | Closed | Closed | Closed | Closed | Closed | Open |
| (Not shown in FIGS. 3-8) | | | | | | |
| Bank II - Flush Input Valve | Closed | Closed | Closed | Closed | Open | Closed |
| Bank II - Flush Output Valve | Closed | Closed | Closed | Closed | Open | Closed |
| Bank II - Stage 1 Input Valve | Open | Open | Open | Closed | Closed | Open |
| Bank II - Stage 1 Output Valve | Open | Open | Open | Closed | Closed | Open |
| Bank II - Stage 3 Input Valve | Closed | Closed | Closed | Open | Closed | Closed |
| Bank II - Stage 3 Output Valve | Closed | Closed | Closed | Open | Closed | Closed |
| Bank II - Permeate Output Valve | Open | Open | Open | Open | Closed | Open |
| (Not shown in FIGS. 3-8) | | | | | | |
| Bank II - Permeate Waste Valve | Closed | Closed | Closed | Closed | Open | Closed |
| (Not shown in FIGS. 3-8) | | | | | | |
| Bank III - Flush Input Valve | Closed | Closed | Closed | Open | Closed | Closed |
| Bank III - Flush Output Valve | Closed | Closed | Closed | Open | Closed | Closed |
| Bank III - Stage 1 Input Valve | Open | Open | Closed | Closed | Open | Open |
| Bank III - Stage 1 Output Valve | Open | Open | Closed | Closed | Open | Open |
| Bank III - Stage 3 Input Valve | Closed | Closed | Open | Closed | Closed | Closed |
| Bank III - Stage 3 Output Valve | Closed | Closed | Open | Closed | Closed | Closed |
| Bank III - Permeate Output Valve | Open | Open | Open | Closed | Open | Open |
| (Not shown in FIGS. 3-8) | | | | | | |
| Bank III - Permeate Waste Valve | Closed | Closed | Closed | Open | Closed | Closed |
| (Not shown in FIGS. 3-8) | | | | | | |
| Bank IV - Flush Input Valve | Closed | Closed | Open | Closed | Closed | Closed |
| Bank IV - Flush Output Valve | Closed | Closed | Open | Closed | Closed | Closed |
| Bank IV - Stage 1 Input Valve | Open | Closed | Closed | Open | Open | Open |
| Bank IV - Stage 1 Output Valve | Open | Closed | Closed | Open | Open | Open |
| Bank IV - Stage 3 Input Valve | Closed | Open | Closed | Closed | Closed | Closed |
| Bank IV - Stage 3 Output Valve | Closed | Open | Closed | Closed | Closed | Closed |
| Bank IV - Permeate Output Valve | Open | Open | Closed | Open | Open | Open |
| (Not shown in FIGS. 3-8) | | | | | | |
| Bank IV - Permeate Waste Valve | Closed | Closed | Open | Closed | Closed | Closed |
| (Not shown in FIGS. 3-8) | | | | | | |
| Bank V - Flush Input Valve | Closed | Open | Closed | Closed | Closed | Closed |
| Bank V - Flush Output Valve | Closed | Open | Closed | Closed | Closed | Closed |
| Bank V - Stage 1 Input Valve | Closed | Closed | Open | Open | Open | Open |
| Bank V - Stage 1 Output Valve | Closed | Closed | Open | Open | Open | Open |
| Bank V - Stage 3 Input Valve | Open | Closed | Closed | Closed | Closed | Closed |
| Bank V - Stage 3 Output Valve | Open | Closed | Closed | Closed | Closed | Closed |
| Bank V - Permeate Output Valve | Open | Closed | Open | Open | Open | Open |
| (Not shown in FIGS. 3-8) | | | | | | |
| Bank V - Permeate Waste Valve | Closed | Open | Closed | Closed | Closed | Closed |
| (Not shown in FIGS. 3-8) | | | | | | |
| Bank VI - Flush Input Valve | Open | Closed | Closed | Closed | Closed | Closed |
| Bank VI - Flush Output Valve | Open | Closed | Closed | Closed | Closed | Closed |
| Bank VI - Stage 1 Input Valve | Closed | Open | Open | Open | Open | Closed |
| Bank VI - Stage 1 Output Valve | Closed | Open | Open | Open | Open | Closed |
| Bank VI - Stage 3 Input Valve | Closed | Closed | Closed | Closed | Closed | Open |
| Bank VI - Stage 3 Output Valve | Closed | Closed | Closed | Closed | Closed | Open |
| Bank VI - Permeate Output Valve | Closed | Open | Open | Open | Open | Open |
| (Not shown in FIGS. 3-8) | | | | | | |
| Bank VI - Permeate Waste Valve | Open | Closed | Closed | Closed | Closed | Closed |
| (Not shown in FIGS. 3-8) | | | | | | |
| Stage 2 Input Valve | Open | Open | Open | Open | Open | Open |
| Stage 2 Output Valve | Open | Open | Open | Open | Open | Open |
| Stage 2 Bypass Valve | Closed | Closed | Closed | Closed | Closed | Closed |
| Stage 2 Flush Input Valve | Closed | Closed | Closed | Closed | Closed | Closed |
| (Not shown in FIGS. 3-8) | | | | | | |
| Stage 2 Flush Output Valve | Closed | Closed | Closed | Closed | Closed | Closed |
| (Not shown in FIGS. 3-8) | | | | | | |
| Bank VII - Permeate Output | Open | Open | Open | Open | Open | Open |
| Valve (Not shown in FIGS. 3-8) | | | | | | |
| Bank VII - Permeate Waste Valve | Closed | Closed | Closed | Closed | Closed | Closed |
| (Not shown in FIGS. 3-8) | | | | | | |
| Bank VIII - Permeate Output Valve | Open | Open | Open | Open | Open | Open |
| (Not shown in FIGS. 3-8) | | | | | | |
| Bank VIII - Permeate Waste Valve | Closed | Closed | Closed | Closed | Closed | Closed |
| (Not shown in FIGS. 3-8) | | | | | | |

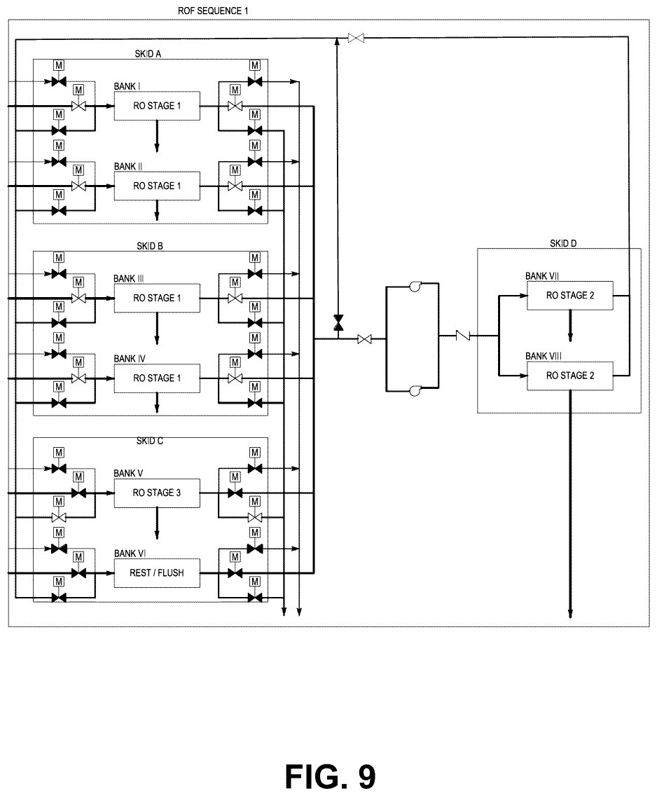

Table 1 and FIGS. 3 to 8 show the flush mode of operation in which the flushing fluid or cleaning fluid flows through the pressure vessels of the associated bank. Alternatively, the bank selected from banks I to VI to not operate as the first RO stage or the third RO stage can be in a rest mode, in which fluid is not flushed through the pressure vessels. The pressure vessels of the bank in rest mode can be isolated from the fluid flow. The associated flush input valve and flush output valve (as well as the first stage input valve, the first stage output valve, the third stage input valve, and the third stage output valve) can be closed for the bank that is in rest mode. In some implementations, the permeate output valve and the permeate waste valve can be closed for the bank in rest mode. FIG. 9 shows an example of the system in a modified first operating configuration in which the bank VI is in rest mode rather than flush mode.

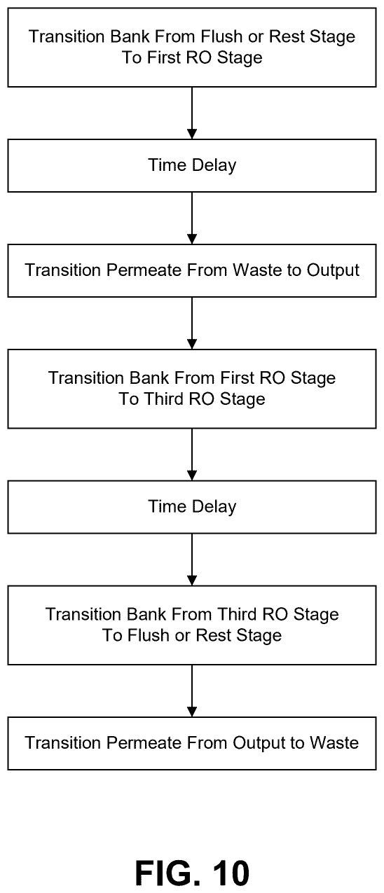

The system can be configured to relieve pressure when transitioning between states. FIG. 10 shows an example method for transitioning between operational configurations for the water treatment system. FIG. 10 will be discussed with reference to the transition between the first operational configuration of FIG. 3 to the second operational configuration of FIG. 4, by way of example. If the valves of the banks that are changing operational modes were all transitioned at the same time, the system may experience water hammer or sudden pressure changes. In some implementations, the system can be configured to use the bank that is in the rest or flush mode to relieve the pressure that can result from the one or more of the transitions. Bank VI can start in the flush mode of operation as shown in FIG. 3, such as with the flush input valve and the flush output valve open. The permeate waste valve can be open and/or the permeate output valve can be closed, so that any permeate created during the flushing is sent to waste. The system can transition bank VI from the flush mode to the first RO stage mode of operation, such as by closing the flush input valve and the flush output valve and by opening the first stage input valve and the first stage output valve. The system can wait for a time delay, during which time five of the banks are in the first RO stage mode of operation and none of the banks are in the flush or rest mode. The time delay can be sufficiently long to let the pressure substantially equalize to the new conditions. The permeate waste valve can remain open and/or the permeate output valve can remain closed during the time delay, so that any permeate created during the time delay is sent to waste. After the time delay the permeate waste valve can be closed and/or the permeate output valve can be opened for bank VI, so that permeate created by bank VI is then sent to the main permeate output (e.g., to a storage tank).

The system can then transition bank V from the first RO stage mode of operation to the third RO stage mode of operation, such as by closing the first stage input valve and the first stage output valve, and by opening the third stage input valve and the third stage output valve. The system can wait for a time delay, during which time two of the bank are in the third RO stage of operation and none of the banks are in the flush or rest mode. The time delay can be sufficiently long to let the pressure substantially equalize to the new conditions. The permeate waste valve can remain closed and/or the permeate output valve can remain opened for bank V during the transition and delay time, so that permeate created by bank V is then sent to the main permeate output (e.g., to a storage tank).

The system can then transition bank IV from the third RO stage mode of operation to the flush mode, such as by closing the third stage input valve and the third stage output valve, and by opening the flush input valve and the flush output valve. The permeate waste valve can be open and/or the permeate output valve can be closed for bank IV, so that any permeate created during the flushing mode is sent to waste. The system can then continuation to operate in the second operational configuration (e.g., shown in FIG. 4).

As mentioned, the time delays can be sufficiently long to let the pressure substantially equalize to the new conditions. For example, the time delay can be about 5 seconds, about 10 seconds, about 15 seconds, about 20 seconds, about 25 seconds, about 30 seconds, about 40 seconds, about 50 seconds, about 60 seconds, or more, or any values therebetween, or any ranges bounded by any of these valves, although other configurations are also possible.

Many alternatives are possible. For example, FIGS. 3 and 4 show the flush state rather than the rest state. In some implementations, the bank in the rest state can be transitioned to the first RO stage, by keeping the flush valve(s) closed while opening the stage one valve(s). The permeate during the following delay can be sent to waste (e.g., if a pervious flush was performed) or sent to the main output (e.g., if no flush was performed). One of the other banks in the first RO stage can be transitioned to the third RO stage similar to the discussion above. Then the other bank that was in the third RO stage can transition to the rest stage, such as by closing the third stage valve and by keeping the flush valves closed. In some cases, the permeate valve(s) can be closed as well, or the permeate waste valve can be opened for the rest bank. In some implementations, a bank can be transitioned to a flush mode for a time and then transitioned to a rest mode, or it can rest for a time before flushing. In some implementations, the system can alternate between the rest mode and flush mode for the individual banks, or the system can use the flush or cleaning mode periodically or intermittently (e.g., 3 rests and 1 flush or clean).

In some implementations, the bank in the flush stage can be transitioned to the third RO stage, then the other bank in the third RO stage can transition to the first RO stage, and then one of the other banks in the first RO stage can transition to the flush or rest stage, with the transition process otherwise similar to the discussion in connection with FIG. 10. Other transition orders could be used. In some cases, the permeate waste valve can be closed and/or the permeate output valve can be open the bank in the flush mode or in transition, so that permeate created by the bank during the flushing is sent to the main permeate output (e.g., to a storage tank). In some implementations, the system can include a waste output valve (e.g., which can be referred to as a throttling valve or a brine valve), which can be used to control the output of waste water (e.g., brine), which can be output to an evaporative basin, for example. In some implementations, the waste output or brine valve can be partially opened to various different levels, which can affect the pressure in the system, such as in the pressure vessels, and can also affect the concentration of output brine. In some implementations, the process of transitioning between states can include opening the waste output or brine valve, such as prior to the state transitions (e.g., prior to the steps of FIG. 10), so that pressure is at least partially relieved through the output waste line during the transitions. After the transitions are completed (e.g., after the steps of FIG. 10), the waste output or brine valve can be transitioned to the desired position for water treatment operation (e.g., by partially closing the valve).

In some embodiments, the system can be operated in a two-stage mode. The banks VII and VIII that are normally used for the second stage can be bypassed or otherwise omitted from the RO process. In some cases, the banks VII and VIII can be flushed or cleaned or they can be in a rest state. The banks I to VI can be used with four of the banks providing a first RO stage and two of the banks providing a second RO stage. In this mode there would be no third RO stage performed. However, the banks that would normally be operable to provide the third RO stage would instead be used to provide the second RO stage. In this mode, the system can output less concentrated brine (e.g., to waste), because it operates with two RO stages instead of three RO stages. In this mode, the system can produce less permeate (e.g., clean or processed water). A use may use the system in the two-stage mode if less permeate is desired (e.g., during a period of less water consumption), or so that the banks VII and/or VIII can be repairs, or receive maintenance, or receive flushing, or cleaning, or rest.

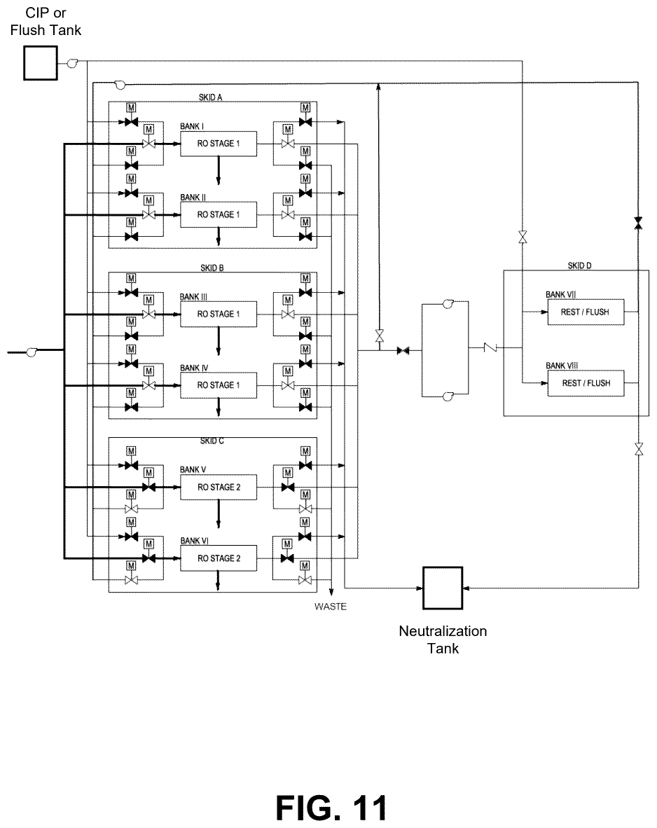

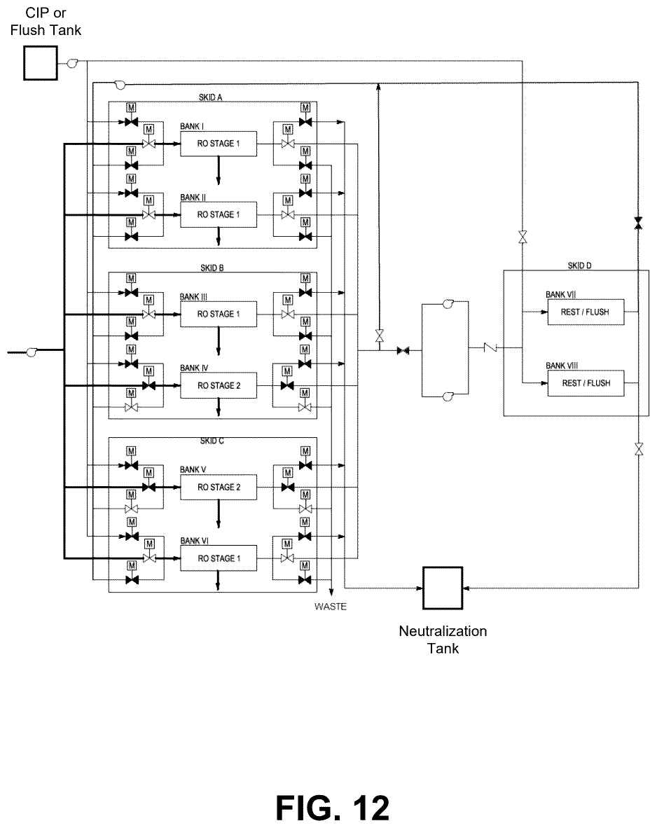

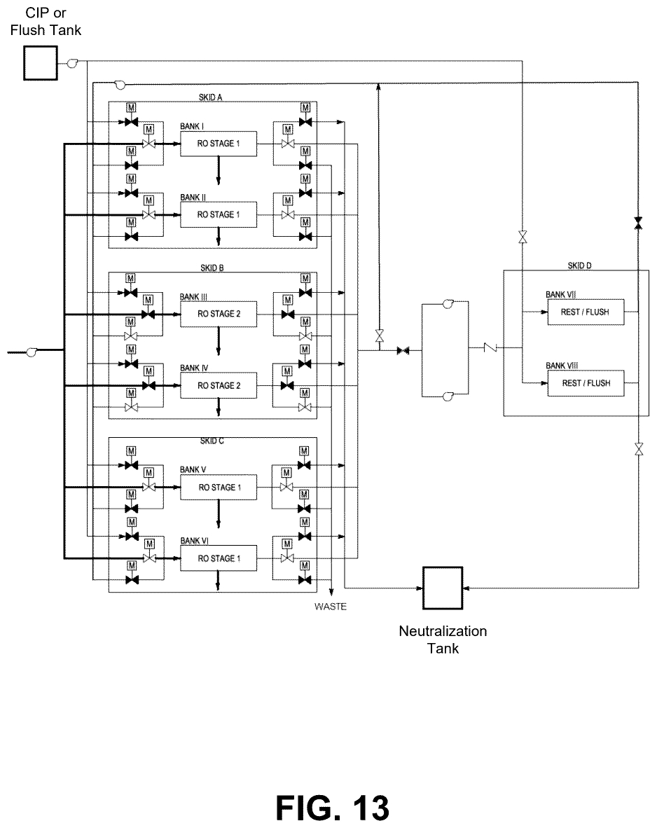

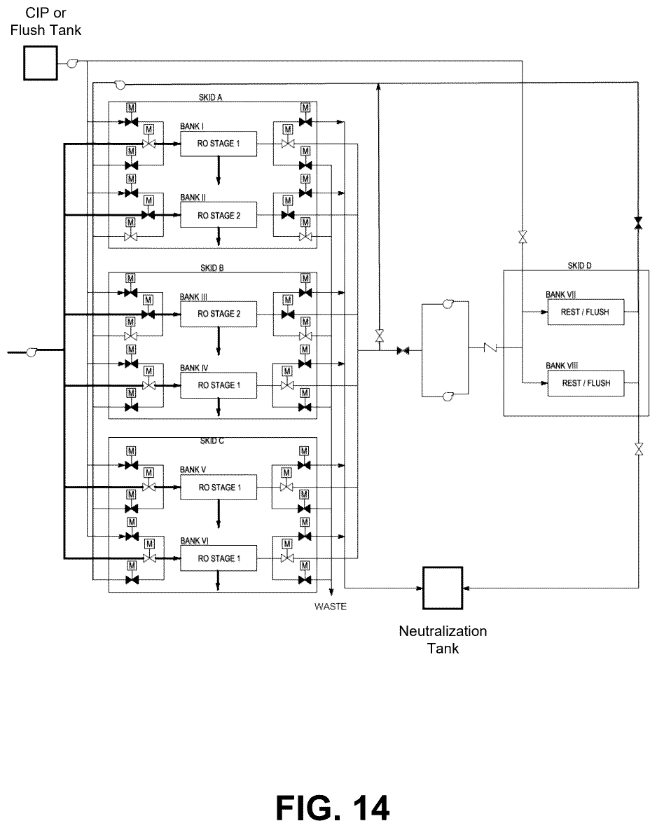

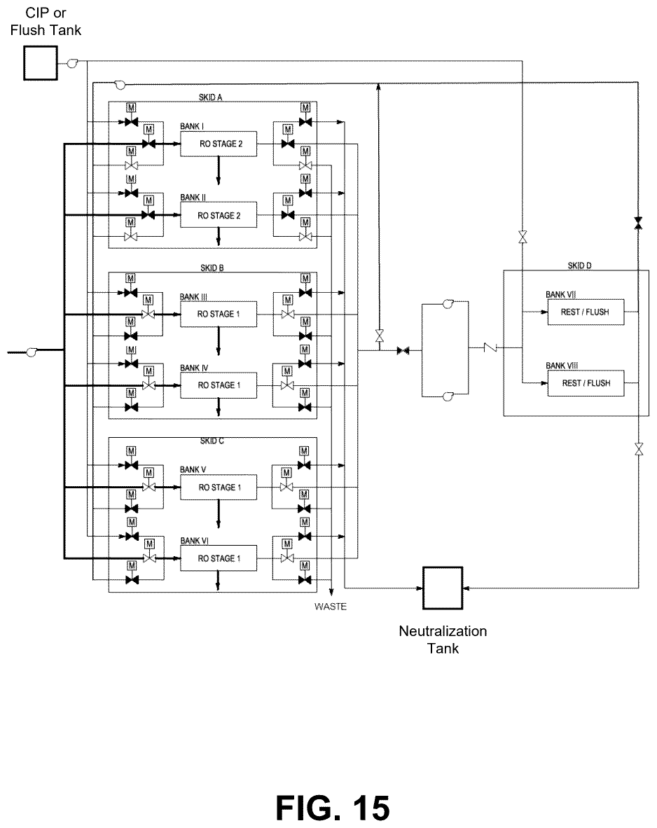

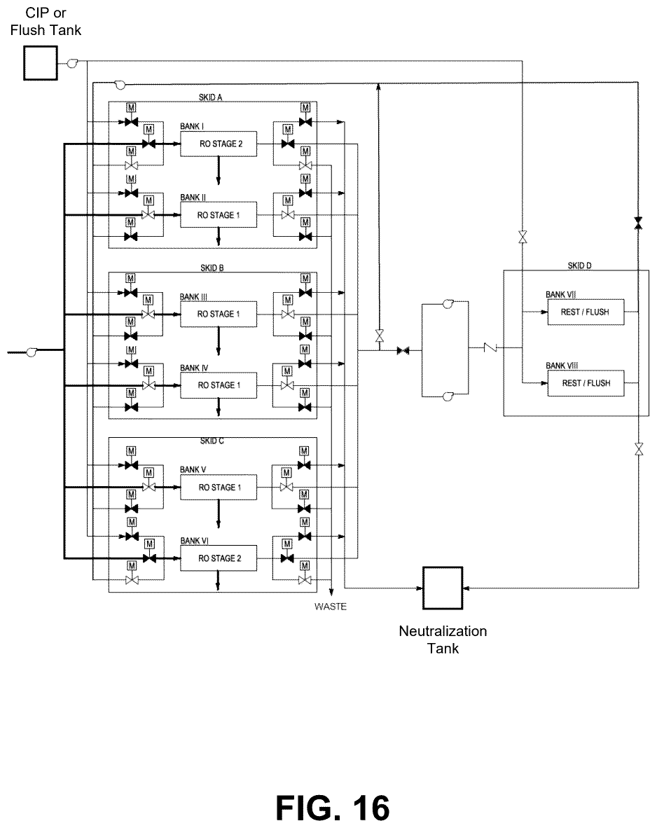

During the two-stage mode, the system can rotate the banks that perform the second RO stage between the available banks I to VI. The banks performing the second RO stage can experience more stress and/or degradation than the banks performing the first RO stage, so rotating the banks can spread the load. The two-stage mode can have six operational configurations. Table 2 lists example valve settings for the six operational configurations. FIG. 11 shows an example of the system in the first operational configuration of the two-stage mode, FIG. 12 shows an example of the system in the second operational configuration of the two-stage mode, FIG. 13 shows an example of the system in the third operational configuration of the two-stage mode, FIG. 14 shows an example of the system in the fourth operational configuration of the two-stage mode, FIG. 15 shows an example of the system in the fifth operational configuration of the two-stage mode, and FIG. 16 shows an example of the system in the sixth operational configuration of the two-stage mode. Other configurations are possible, as discussed herein. For simplicity, some components are omitted from view in FIGS. 11 to 16. The system presented in FIGS. 11 to 16 can, for example, include all the features of FIG. 2 or of any of the other embodiments disclosed herein.

TABLE 2

| Configuration | 1 | 2 | 3 | 4 | 5 | 6 |
|---|---|---|---|---|---|---|
| Bank I - Flush Input Valve | Closed | Closed | Closed | Closed | Closed | Closed |
| Bank I - Flush Output Valve | Closed | Closed | Closed | Closed | Closed | Closed |
| Bank I - Stage 1 Input Valve | Open | Open | Open | Open | Closed | Closed |
| Bank I - Stage 1 Output Valve | Open | Open | Open | Open | Closed | Closed |
| Bank I - Stage 3 Input Valve | Closed | Closed | Closed | Closed | Open | Open |
| Bank I - Stage 3 Output Valve | Closed | Closed | Closed | Closed | Open | Open |
| Bank I - Permeate Output Valve | Open | Open | Open | Open | Open | Open |
| (Not shown in FIGS. 11-16) | | | | | | |
| Bank I - Permeate Waste Valve | Closed | Closed | Closed | Closed | Closed | Closed |
| (Not shown in FIGS. 11-16) | | | | | | |
| Bank II - Flush Input Valve | Closed | Closed | Closed | Closed | Closed | Closed |
| Bank II - Flush Output Valve | Closed | Closed | Closed | Closed | Closed | Closed |
| Bank II - Stage 1 Input Valve | Open | Open | Open | Closed | Closed | Open |
| Bank II - Stage 1 Output Valve | Open | Open | Open | Closed | Closed | Open |
| Bank II - Stage 3 Input Valve | Closed | Closed | Closed | Open | Open | Closed |
| Bank II - Stage 3 Output Valve | Closed | Closed | Closed | Open | Open | Closed |
| Bank II - Permeate Output Valve | Open | Open | Open | Open | Open | Open |
| (Not shown in FIGS. 11-16) | | | | | | |
| Bank II - Permeate Waste Valve | Closed | Closed | Closed | Closed | Closed | Closed |
| (Not shown in FIGS. 11-16) | | | | | | |
| Bank III - Flush Input Valve | Closed | Closed | Closed | Closed | Closed | Closed |
| Bank III - Flush Output Valve | Closed | Closed | Closed | Closed | Closed | Closed |
| Bank III - Stage 1 Input Valve | Open | Open | Closed | Closed | Open | Open |
| Bank III - Stage 1 Output Valve | Open | Open | Closed | Closed | Open | Open |
| Bank III - Stage 3 Input Valve | Closed | Closed | Open | Open | Closed | Closed |
| Bank III - Stage 3 Output Valve | Closed | Closed | Open | Open | Closed | Closed |
| Bank III - Permeate Output Valve | Open | Open | Open | Open | Open | Open |
| (Not shown in FIGS. 11-16) | | | | | | |
| Bank III - Permeate Waste Valve | Closed | Closed | Closed | Closed | Closed | Closed |
| (Not shown in FIGS. 11-16) | | | | | | |
| Bank IV - Flush Input Valve | Closed | Closed | Closed | Closed | Closed | Closed |
| Bank IV - Flush Output Valve | Closed | Closed | Closed | Closed | Closed | Closed |
| Bank IV - Stage 1 Input Valve | Open | Closed | Closed | Open | Open | Open |
| Bank IV - Stage 1 Output Valve | Open | Closed | Closed | Open | Open | Open |
| Bank IV - Stage 3 Input Valve | Closed | Open | Open | Closed | Closed | Closed |
| Bank IV - Stage 3 Output Valve | Closed | Open | Open | Closed | Closed | Closed |
| Bank IV - Permeate Output Valve | Open | Open | Open | Open | Open | Open |
| (Not shown in FIGS. 11-16) | | | | | | |
| Bank IV - Permeate Waste Valve | Closed | Closed | Closed | Closed | Closed | Closed |
| (Not shown in FIGS. 11-16) | | | | | | |
| Bank V - Flush Input Valve | Closed | Closed | Closed | Closed | Closed | Closed |
| Bank V - Flush Output Valve | Closed | Closed | Closed | Closed | Closed | Closed |
| Bank V - Stage 1 Input Valve | Closed | Closed | Open | Open | Open | Open |
| Bank V - Stage 1 Output Valve | Closed | Closed | Open | Open | Open | Open |
| Bank V - Stage 3 Input Valve | Open | Open | Closed | Closed | Closed | Closed |
| Bank V - Stage 3 Output Valve | Open | Open | Closed | Closed | Closed | Closed |
| Bank V - Permeate Output Valve | Open | Open | Open | Open | Open | Open |
| (Not shown in FIGS. 11-16) | | | | | | |
| Bank V - Permeate Waste Valve | Closed | Closed | Closed | Closed | Closed | Closed |
| (Not shown in FIGS. 11-16) | | | | | | |
| Bank VI - Flush Input Valve | Closed | Closed | Closed | Closed | Closed | Closed |
| Bank VI - Flush Output Valve | Closed | Closed | Closed | Closed | Closed | Closed |
| Bank VI - Stage 1 Input Valve | Closed | Open | Open | Open | Open | Closed |
| Bank VI - Stage 1 Output Valve | Closed | Open | Open | Open | Open | Closed |
| Bank VI - Stage 3 Input Valve | Open | Closed | Closed | Closed | Closed | Open |
| Bank VI - Stage 3 Output Valve | Open | Closed | Closed | Closed | Closed | Open |
| Bank VI - Permeate Output Valve | Open | Open | Open | Open | Open | Open |
| (Not shown in FIGS. 11-16) | | | | | | |
| Bank VI - Permeate Waste Valve | Closed | Closed | Closed | Closed | Closed | Closed |
| (Not shown in FIGS. 11-16) | | | | | | |
| Stage 2 Input Valve | Closed | Closed | Closed | Closed | Closed | Closed |
| Stage 2 Output Valve | Closed | Closed | Closed | Closed | Closed | Closed |
| Stage 2 Bypass Valve | Open | Open | Open | Open | Open | Open |
| Stage 2 Flush Input Valve | Open | Open | Open | Open | Open | Open |
| Stage 2 Flush Output Valve | Open | Open | Open | Open | Open | Open |
| Bank VII - Permeate Output | Closed | Closed | Closed | Closed | Closed | Closed |
| Valve (Not shown in FIGS. 11-16) | | | | | | |
| Bank VII - Permeate Waste Valve | Open | Open | Open | Open | Open | Open |
| (Not shown in FIGS. 11-16) | | | | | | |
| Bank VIII - Permeate Output Valve | Closed | Closed | Closed | Closed | Closed | Closed |
| (Not shown in FIGS. 11-16) | | | | | | |
| Bank VIII - Permeate Waste Valve | Open | Open | Open | Open | Open | Open |
| (Not shown in FIGS. 11-16) | | | | | | |

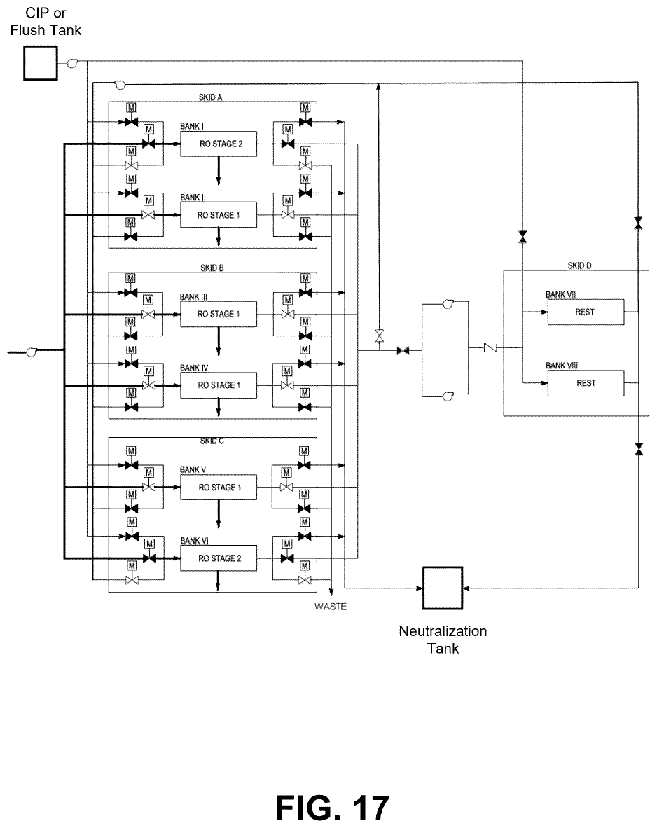

In Table 2 and FIGS. 11 to 16, the banks VII and VIII are shown in a flush mode, in which the stage two flush valves are open. However, in some cases, the banks VII and VIII can alternatively be in a rest or isolated mode. FIG. 17 shows, for example, the sixth operational configuration of the two-stage mode in which the stage two flush valves are closed, and the banks VII and VIII are in the rest mode. Any of the other operational configurations can have the banks VII and VIII in the rest mode, as well. In some cases, the banks VII and VIII can be flushed during one of the six configurations, and can be in rest mode during the other five configurations. The banks VII and VIII can be flushed or cleaned as needed or periodically or intermittently. During the rest mode, the permeate output valve and/or the permeate waste valve can be closed. In some cases, the pressure vessels of banks VII and/or VIII can be isolated when in the rest mode.

In some implementations, the system can include a fluid line from the outputs of the banks VII and VIII (e.g., the second RO stage banks) to waste, and a stage two waste valve can control whether fluid is permitted to be output from banks VII and VIII to waste. With that configuration, the system could operate in a second two-stage mode, in which banks VII and VIII can operate as the second RO stage, and four of the banks I to VI can operate as the first RO stage. The other two banks of the banks I to VI can be in the flush or rest mode.

In some cases, the system can operate with two of the banks I to VI as the first RO stage and one of the banks I to VI as the second RO stage. The other banks can be in the rest of flush configuration. The roles of the banks can be rotated through the banks I to VI, for example similar to the other examples discussed herein. This approach would produce less treated water and would produce waste with similar brine concentration to the other two-stage mode discussed herein.

The system can include a controller, which can be configured to operate the valves (e.g., using solenoids or other actuators), the pumps, and other features, such as to implement the operational configurations described herein. In some cases, the system can include flow meters, which can measure the flow of fluid at certain positions in the system can report the fluid flow information to the controller. The controller can adjust the one or more pumps based at least in part on the flow information, such as to achieve target flow set points at the monitored locations in the system. The controller can identify a potential malfunction based at least in part on the flow information, and can issue an alert or take remedial action. For example, if the system received flow information indicating flow at a location that should not have flow, the system can determine that a valve may have malfunctioned. The system can then issue an alert or notification for a user to perform maintenance or investigate. In some cases, the system can automatically change the operational configuration of the system in response to the identified potential malfunction or issue. For example, if a potential malfunction is identified on bank VI, then the system can transition to the sixth operational configuration of FIG. 9, which can put the bank VI in the rest or isolated configuration.

The controller can include one or more computer processors, which can be general-purpose processors, such as on a general-purpose computer system, or the one or more processors can be specialized processors (e.g., application specific integrated circuits or the like) which can be configured to perform operations to implement the features disclosed herein. The controller can include computer-readable memory (e.g., non-transitory computer-readable memory), which can store instructions that can be executed by the one or more processors to implement the features disclosed herein.

In some implementations, the controller can include a user interface, which can receive input from a user. For example, the user can specify a desired operational configuration and the controller can implement the specified operational configuration in response to the user input. The user can select between various modes and can set or adjust various operational parameters using the user interface. For example, the user could set a rotation order and/or rotation time for the controller to implement. The user interface can output information to the user, such as alerts or notifications, or operational parameters (e.g., current configuration or flow rates or output amount, etc.).

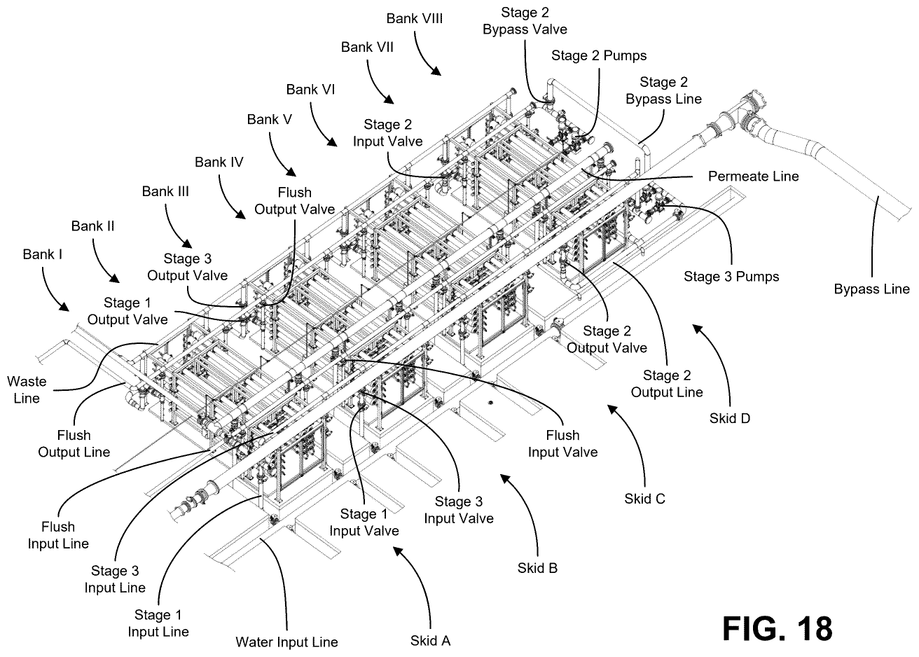

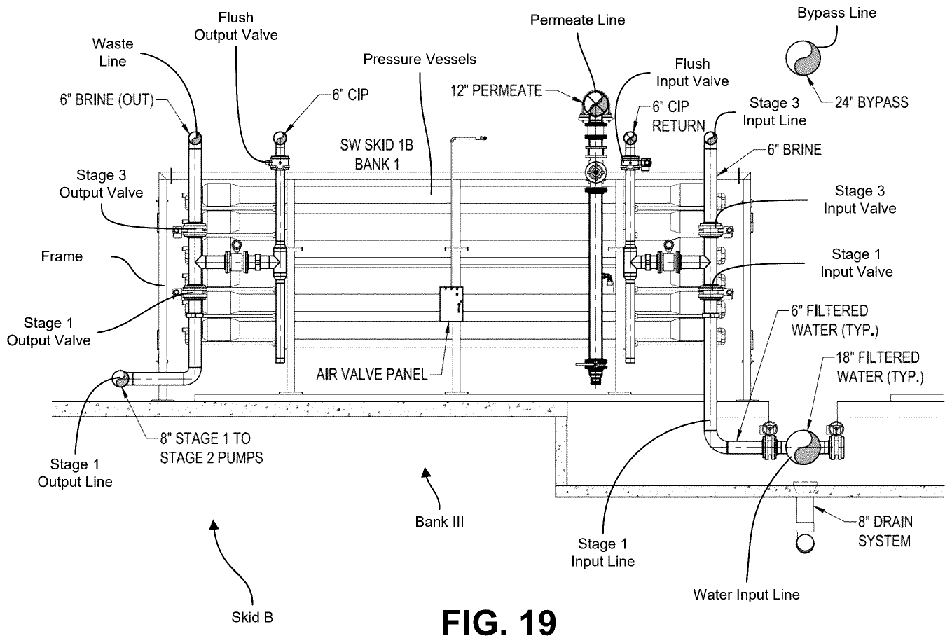

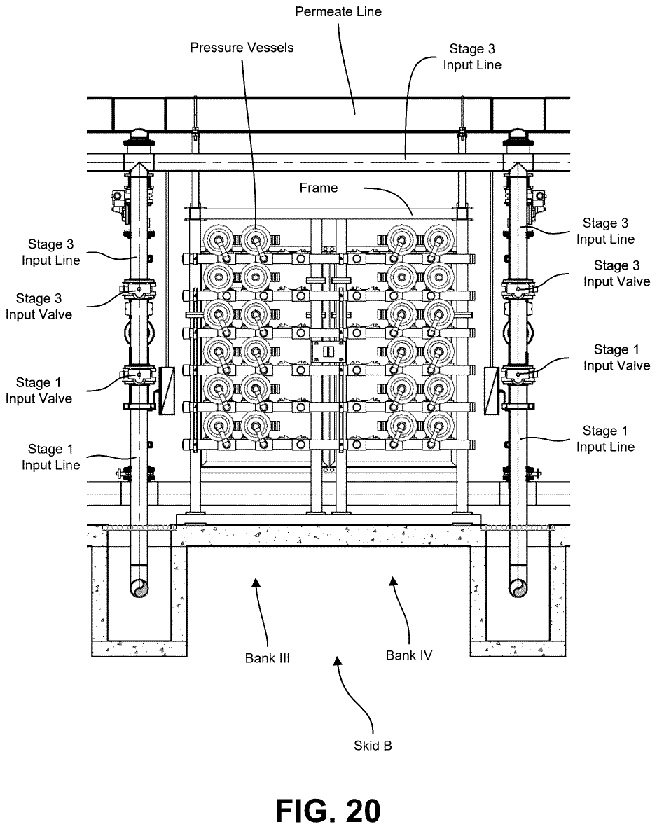

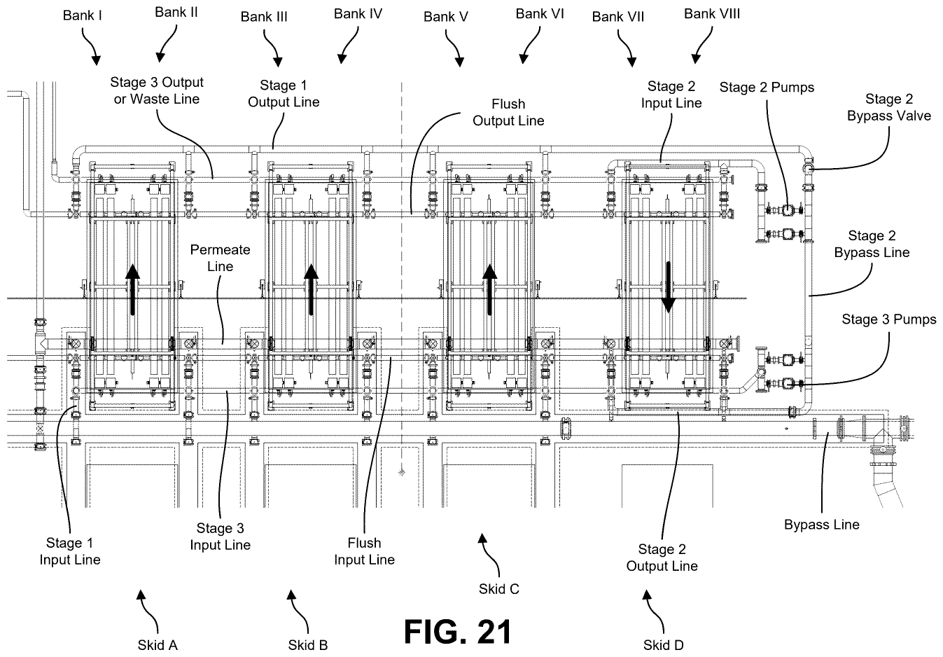

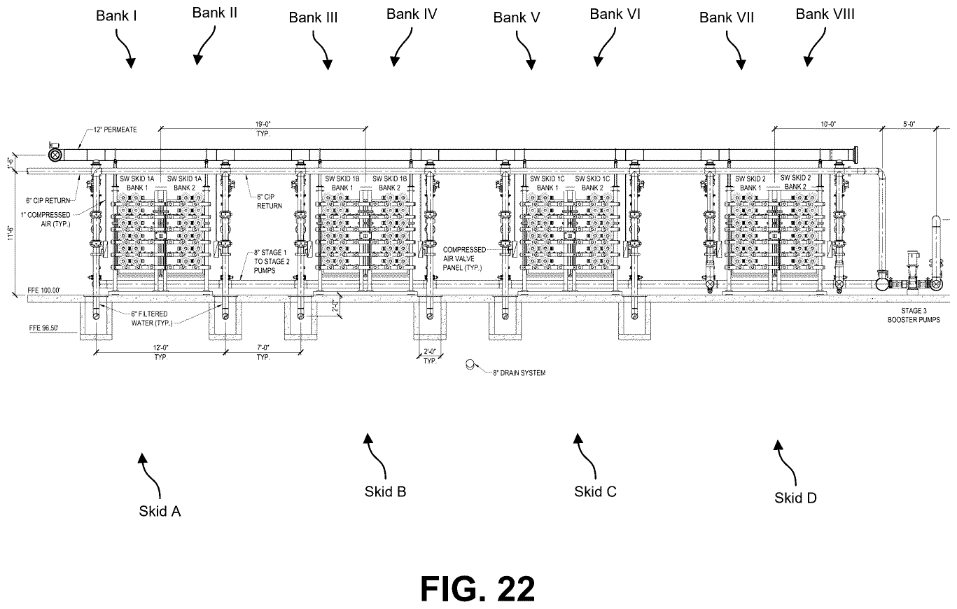

FIG. 18 shows a perspective view of an example of a fluid treatment system. FIG. 19 shows an elevation side view of Skid B, showing bank III. FIG. 20 is an elevation front view of Skid B, showing banks III and IV. FIG. 21 is a plan view of the fluid treatment system. FIG. 22 is an elevation front view of the fluid treatment system. The skids A, B, and C can be substantially the same. The banks I, III, and V can be substantially the same as each other. Banks II, IV, and VI can be substantially the same as each other, and can have a mirrored configuration that is functionally substantially the same as banks I, III, and V. Banks VII and VIII can be different from banks I to VI, such as to provide the second RO stage, as discussed herein, and banks VII and VIII can have mirrored configurations that are substantially the same as each other in function.

Each skid can include a frame or support structure, which can support the pressure vessels. Banks I and II can share the same frame of skid A. Banks III and IV can share the same frame of skid B. Banks V and VI can share the same frame of skid C. Banks VII and VIII can share the same frame of skid D. In some configurations, 8 skids could be used, with each skid having one bank. In some configurations, the arrangement with 4 skids and 8 banks can be modular. For example, 8 skids could be used, with each skid still divided into two banks.

In the illustrated examples, each skid has 24 pressure vessels and each bank has 12 pressure vessels, but any suitable number of pressure vessels can be used for each skid or frame. In some cases, the number of pressure vessels can be limited by the sizes available for transportation or access for maintenance or repairs, and can also depend on the size (e.g., diameter) of the pressure vessels. The skid can include 6 pressure vessels wide and 6 pressure vessels high, in some configurations. In the illustrated examples, two of the columns on the skid are left empty, but could be filled, depending on the directed volume of water processing. By way of example, each bank can include 1, 2, 4, 8, 12, 18, 24, 36, 48, 64, or more pressure vessels, or any values therebetween, or any ranges between any of the these values, although other configurations are possible. Each of the banks can include the same number of pressure vessels.

### Additional Information

In some embodiments, the methods, techniques, microprocessors, and/or controllers described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. The instructions can reside in RAM memory, flash memory, ROM memory, EPROM memory, EEPROM memory, registers, hard disk, a removable disk, a CD-ROM, or any other form of a non-transitory computer-readable storage medium. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

The microprocessors or controllers described herein can be coordinated by operating system software, such as iOS, Android, Chrome OS, Windows XP, Windows Vista, Windows 7, Windows 8, Windows 10, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

The microprocessors and/or controllers described herein may implement the techniques described herein using customized hard-wired logic, one or more ASICs or FPGAs, firmware and/or program logic which causes microprocessors and/or controllers to be a special-purpose machine. According to one embodiment, parts of the techniques disclosed herein are performed a controller in response to executing one or more sequences instructions contained in a memory. Such instructions may be read into the memory from another storage medium, such as storage device. Execution of the sequences of instructions contained in the memory causes the processor or controller to perform the process steps described herein. In alternative embodiments, hard-wired circuitry may be used in place of or in combination with software instructions.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the techniques described herein may be implemented in analog circuitry or mixed analog and digital circuitry.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, this disclosure covers all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including ambient temperature and pressure.

1. A water treatment system comprising:
an input configured to receive input water for treatment;
eight banks of pressure vessels;
wherein four of the eight banks of pressure vessels are operable to:
receive the input water;
perform a first stage treatment on the input water;
output first stage permeate water; and
output first stage output water;
wherein two of the eight banks of pressure vessels are operable to:
receive the first stage output water;
perform a second stage treatment on the first stage output water;
output second stage permeate water; and
output second stage output water;
wherein one of the eight banks of pressure vessels is operable to:
receive the second stage output water;
perform a third stage treatment on the second stage output water;
output third stage permeate water; and
output third stage output water; and
wherein one of the eight banks of pressure vessels is in a rest or flush state.

2. The water treatment system of claim 1, wherein the water treatment system is a desalination water treatment system.

3. The water treatment system of claim 1, wherein the water treatment system uses reverse osmosis.

4. The water treatment system of claim 1, wherein the water treatment system is operable to rotate six of the eight banks of pressure vessels between:
a first stage treatment mode of operation;
a third stage treatment mode of operation; and
the rest or flush state.

5. The water treatment system of claim 4, wherein the two of the eight banks that are operable to perform the second stage treatment are operable to continue performing the second stage treatment while the six of the eight banks are rotated between the first stage treatment mode of operation, the third stage treatment mode of operation, and the rest or flush state.

6. The water treatment system of claim 4, comprising a controller that is configured to operate a plurality of valves to automatically rotate the six of the eight banks.

7. The water treatment system of claim 1, wherein the rest or flush state is a flush state in which the water treatment system is operable to deliver flushing fluid to the pressure vessels of the one of the eight banks that is in the flush state.

8. The water treatment system of claim 1, wherein the rest or flush state is a rest state in which the water treatment system is operable to isolate the pressure vessels of the one of the eight banks that is in the rest state.

9. (canceled)

10. (canceled)

11. The water treatment system of claim 1, wherein the water treatment system includes one or more bypass valves that are operable to bypass the two of the eight banks of pressure vessels to operate the water treatment system in a two stage treatment mode using six of the banks of pressure vessels.

12. The water treatment system of claim 11, wherein in the two stage treatment mode:
four of the six banks of pressure vessels are operable to:
receive the input water;
perform a first stage treatment on the input water;
output first stage permeate water; and
output first stage output water; and
two of the six banks of pressure vessels are operable to:
receive the first stage output water;
perform a second stage treatment on the first stage output water;
output second stage permeate water; and
output second stage output water.

13. The water treatment system of claim 12, wherein the bypassed two of the eight banks are in a flush or rest state in the two stage treatment mode.

14. The water treatment system of claim 12, wherein the water treatment system is operable to rotate the six of the eight banks of pressure vessels between:
a first stage treatment mode of operation; and
a second stage treatment mode of operation.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A water treatment system comprising:
a first group of pressure vessels and one or more valves operable to selectively operate the first group in a first treatment stage mode of operation, a third treatment stage mode of operation, and a flush or rest mode of operation;
a second group of pressure vessels and one or more valves operable to selectively operate the second group in the first treatment stage mode of operation, the third treatment stage mode of operation, and the flush or rest mode of operation;
a third group of pressure vessels and one or more valves operable to selectively operate the third group in the first treatment stage mode of operation, the third treatment stage mode of operation, and the flush or rest mode of operation;
a fourth group of pressure vessels and one or more valves operable to selectively operate the fourth group in the first treatment stage mode of operation, the third treatment stage mode of operation, and the flush or rest mode of operation;
a fifth group of pressure vessels and one or more valves operable to selectively operate the fifth group in the first treatment stage mode of operation, the third treatment stage mode of operation, and the flush or rest mode of operation;
a sixth group of pressure vessels and one or more valves operable to selectively operate the sixth group in the first treatment stage mode of operation, the third treatment stage mode of operation, and the flush or rest mode of operation; and
a seventh group of pressure vessels operable in a second treatment stage mode of operation.

27. The water treatment system of claim 26, further comprising an eighth group of pressure vessels operable in the second treatment stage mode of operation.

28. The water treatment system of any one of claim 27, wherein a first frame supports the first group of pressure vessels and the second group of pressure vessels, wherein a second frame supports the third group of pressure vessels and the fourth group of pressure vessels, wherein a third frame supports the fifth group of pressure vessels and the sixth group of pressure vessels, and wherein a fourth frame supports the seventh group of pressure vessels and the eighth group of pressure vessels.

29. The water treatment system of claim 26, wherein each of the groups of pressure vessels includes the same number of pressure vessels.

30. The water treatment system of claim 26, comprising a controller operable to rotate the first group of pressure vessels, the second group of pressure vessels, the third group of pressure vessels, the fourth group of pressure vessels, the fifth group of pressure vessels, and the sixth group of pressure vessels between the first treatment stage mode of operation, the third treatment stage mode of operation, and the flush or rest mode of operation.

31. The water treatment system of claim 30, wherein the controller is configured to operate four of the groups of pressure vessels in the first treatment stage mode of operation, to operate one group of the pressure vessels in the third treatment stage mode of operation, and to operate one group of the pressure vessels in the flush or rest mode of operation.

32. The water treatment system of claim 26, comprising one or more valves configured to bypass the seventh group of pressure vessels.

33. The water treatment system of claim 32, wherein the water treatment system is operable in a two stage treatment mode when the seventh group of pressure vessels is bypassed.

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)
